(19) United States
(12) Patent Application Publication
(10) Pub. No.: US 2010/0147975 A1
(43) Pub. Date: Jun. 17, 2010

(54) IDENTIFICATION NAMEPLATE FOR A DIESEL ENGINE FUEL INJECTOR

(76) Inventors: Ted Stewart, Ponte Vedra Beach, FL (US); James Napier, Atlantic Beach, FL (US)

Correspondence Address: Steven L. Schmid, 1824 Hickory Trace Dr., Fleming Island, FL, 32003, US

(21) Appl. No.: 12/612,093

(22) Filed: Nov. 4, 2009

Related U.S. Application Data
(60) Provisional application No. 61/111,347, filed on Nov. 5, 2008.

(51) Int. Cl. F02M 63/00; G09F 3/00

(52) U.S. Cl. 239/533.2; 40/299.01

(57) ABSTRACT

Disclosed is a nameplate which can provide both part and manufacturer information and timing guidance is a functional identification nameplate for a diesel fuel injector. The nameplate is attached to the top of the injector body and provides an alternative to the practice of re-machining the injector body's front face to remove past information in the remanufacture of the injector. Additionally, the nameplate serves as a functional static timing reference indicator in providing a vertical riser extending up from the top of the injector.

### RELATED APPLICATION

This application relies upon U.S. Provisional Application Ser. No. 61/111,347 filed Nov. 5, 2008, the content of which is hereby incorporated in its entirety.

### TECHNICAL FIELD

The present invention relates to an apparatus for identifying a diesel engine fuel injector and in greater detail the invention includes a functional nameplate identifying a part number and manufacturer and provides a functional static timing indicator

### BACKGROUND

Information pertaining to the fuel injector is marked on the flat front face of the injector body assembly block. The markings or indicia, are usually in the form of alpha-numeric characters, are stamped on with individual steel dies (one for each character) that incise the characters into the face. The face is finished with a machined surface on which the incised characters are visible. The information can be stamped in ink, but ink markings are generally unsatisfactory since they can rub off or fade during the use of the injector.

The stamped-on information typically includes information that may be important to the long-term economic use of the injector. Such information includes a unique serial number for each one of a series of injectors. Normally, the same part number would apply to each member of the series, but each member would have its own unique serial number. The information may include, directly or in coded key, manufacturer, year and month of manufacture, customer prefix and suffix numbers, part number, serial number, and warranty expiration date.

Mechanical diesel fuel injectors are remanufactured from time to time. This work may be done either by the original manufacturer or by other companies specializing in rebuilding. Railroads and truck lines, for example, have injectors rebuilt as a routine operating practice.

When an injector is remanufactured, the information to be marked on it must be updated. Generally, the available area for stamping information on the front face is limited, and the old information must be removed to make room for updated information, and also to eliminate any potential for confusion between old and new information. The practice is to machine or grind the flat front face to a depth sufficient to erase all the old markings and then stamp the new set of information items on the freshly exposed “new” surface of the front face. After this has been done several times, the body assembly block falls short of specified dimensional tolerances and must be replaced. Since the body assembly block is a major component of the overall injector assembly, the requirement that the block be replaced say every two or three rebuilding cycles represents a significant cost factor.

Additionally, there have long been tools for measuring the elevation of a diesel fuel injector follower relative to the injector body to determine if the injector is properly adjusted. Proper tuning is important because maladjustment leads to poor fuel efficiency and a heavy discharge of unburned gaseous pollutants.

In the adjustment of the injector various tools are used to adjust the elevation of the follower. Typically a tool is used to adjust the elevation until the tool arm portion just touches the top of the follower. This type of tool is calibrated during manufacture to one permanent tuning measurement. Therefore, a disadvantage of this tool is that a shop which services different types of diesel engines must purchase a separate tool for each engine type.

Thus, what is needed is an apparatus and method capable of marking a diesel fuel injector without the need of refinishing the injector body assembly block with new information. Additionally, what is needed is a durable marking system that may be used in the remanufacture of injectors. Furthermore what is needed is a method and apparatus for providing a ready timing tool specific to the injector type.

### SUMMARY

The present invention provides a functional identification nameplate for a diesel fuel injector. The nameplate is attached to the top of the injector body and provides an alternative to the practice of re-machining the injector body's front face to remove past information in the remanufacturing of the injector. Additionally, the nameplate serves as a functional static timing reference indicator in providing a vertical riser extending up from the top of the injector. The nameplate can provide both part and manufacturer information and timing guidance.

In greater detail, the invention includes an identification nameplate for a diesel engine fuel injector wherein the injector includes an injector body having holes at the top of the injector body for receiving filter caps. The body further includes an injector stud for securing the injector. The nameplate includes a mounting portion for securing the nameplate to the top of the injector body. The mounting portion has first and second opposed interface surfaces and a hole positioned within the interface surfaces for receiving the injector stud.

Additionally, the mounting portion includes a pair of holes positioned within the interface surfaces wherein the pair of holes are aligned with the holes in the injector body which receive the filter caps of the injector. The pair of holes aligned with the filler cap openings of the injector body may be sized to fit a sealing washer to reside within the inner diameter of the pair of holes. The nameplate also includes an identification portion attached to the mounting portion, the identification portion including indicia.

Additionally, the nameplate may be a unitary piece typically comprised of a metal such as stainless steel. The indicia can include a part number identification and/or manufacturing process information. The identification portion in one embodiment may be integral with the mounting portion and is perpendicular to the mounting portion and the identification portion extends over a portion of the fount face of the injector body.

In a further embodiment, the nameplate includes a vertical portion attached to the mounting portion and extending up from the top of the injector body. The vertical portion may include indicia such as the manufacture of the injector and/or the vertical portion may have a distinct color added or included. The vertical portion can serve as a static timing reference indicator whereby the height of the vertical portion is thus sized to fit such timing requirements of the particular injector.

An additional embodiment includes a fuel injector mechanism for regulating the volume of fuel injected. The injector includes a body housing a rotatable plunger slidably fitting within a bushing and a pair of holes at the top of the injector body for receiving filter caps and an injector stud for securing the injector. The injector further includes a first and a second port formed within the bushing and a nozzle tip. Additionally, the plunger includes a first and a second opposed ridge and a channel positioned between and defined by the first and second opposed ridges and encircling an axial portion of the plunger.

The injector also includes a nameplate attached to the fuel injector including a mounting portion having first and second opposed interface surfaces and a hole positioned within the interface surfaces for receiving the injector stud. The mounting portion further including a pair of holes positioned within the interface surfaces. The pair of holes are aligned with the holes in the injector body which receive the filter caps of the injector. An identification portion attached to the mounting portion, the identification portion including indicia. Additionally, a vertical portion attached to the mounting portion and extending up from the top of the injector body.

### DRAWINGS

In the Drawings

FIG. 1 illustrates an embodiment of the present apparatus showing both a side view and frontal view of the nameplate;

FIG. 2 illustrates a top view of the nameplate showing both the pair of holes and the center hole fitting the post of the injector;

FIG. 3 is a depiction of the nameplate attached to the injector and the washers within the pair of holes; and

FIG. 4 depicts the nameplate attached to the injector in a frontal view of the combination of the two.

### DETAILED DESCRIPTION

Disclosed is a functional identification nameplate for a diesel fuel injector. The nameplate is attached to the top of the injector body and provides an alternative to the practice of re-machining the injector body's front face to remove past information in the remanufacture of the injector. Additionally, the nameplate serves as a functional static timing reference indicator in providing a vertical riser extending up from the top of the injector. The nameplate can provide both part and manufacturer information and timing guidance.

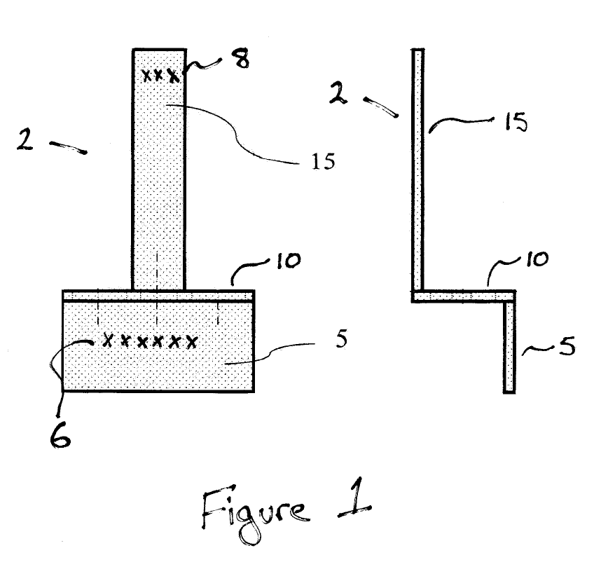

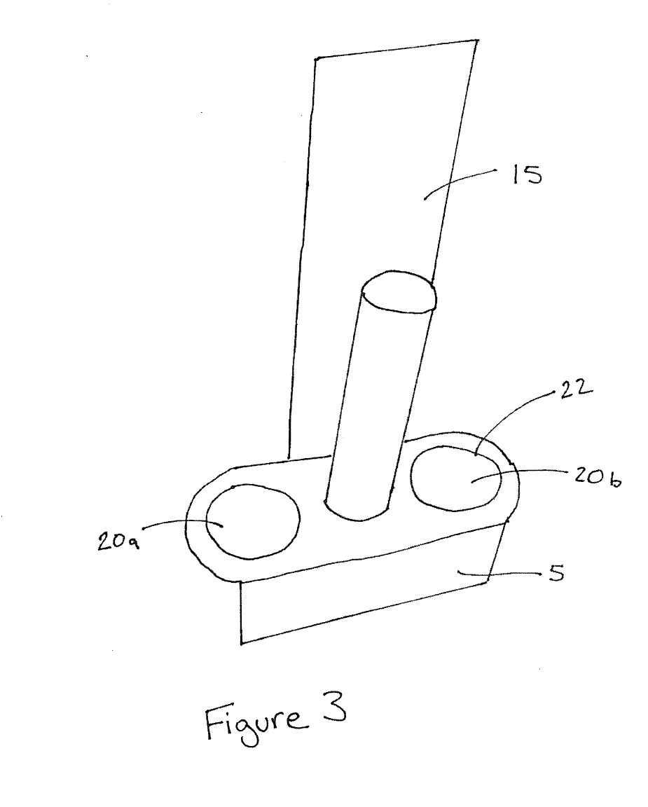

Referring now in greater detail to the drawings in which like numerals indicate like items throughout the several views, FIGS. 1-4 depict the fuel line gasket for use with a diesel fuel injector.

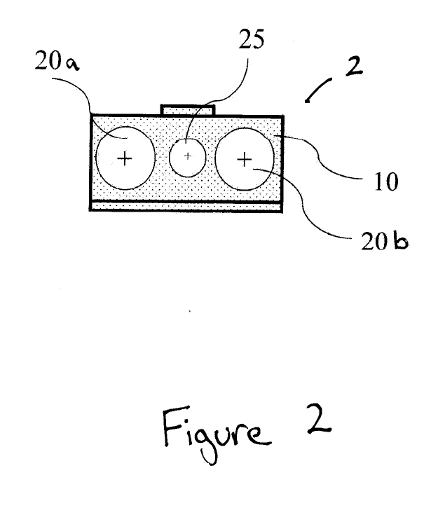

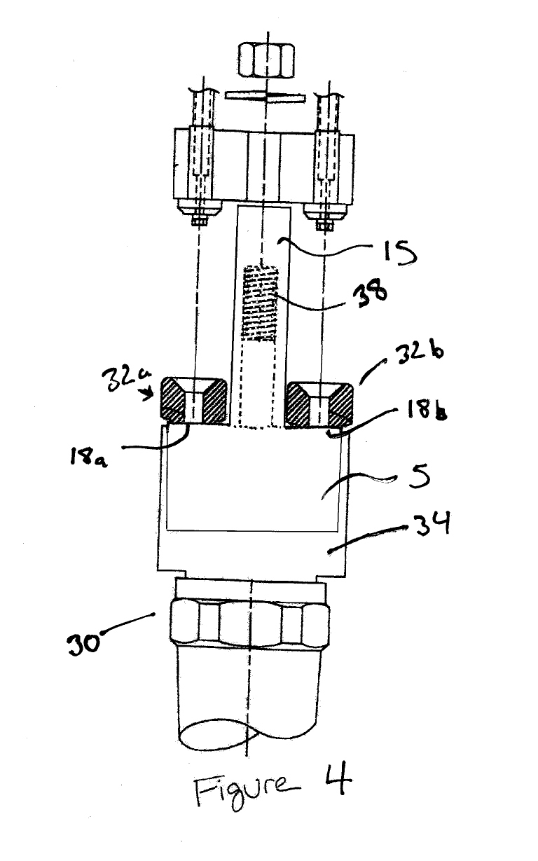

FIG. 1 depicts embodiments of the present nameplate 2. Shown in FIG. 1 is the mounting portion 10 including a pair of holes 20a and 20b shown in FIG. 2 positioned within the interface surfaces of the mounting portion 10. The pair of holes 20(a-b) are aligned with the holes 18(a-b) in the injector body 30 as shown in FIG. 4 which receive the filter caps 32(a-b) of the injector. The pair of holes 20(a-b) aligned with the filler cap openings of the injector body 30 may be sized to fit a sealing washer 22 to reside within the inner diameter of the pair of holes 20(a-b). The nameplate 2 also includes an identification portion 5 attached to the mounting portion 10. The identification portion 5 may include indicia 6.

The nameplate 2 may be a unitary piece typically comprised of a metal such as stainless steel. The indicia (6 and 8) can include a part number identification and/or manufacturing process information. The identification portion 5 in one embodiment may be integral with the mounting portion 10 and is perpendicular to the mounting portion 10 and the identification portion 5 extends over a portion of the fount face 34 of the injector body 30 as shown in FIG. 4.

In a further embodiment, the nameplate 2 includes a vertical portion 15 attached to the mounting portion 10 and extending up from the top of the injector body 30. The vertical portion 15 may include indicia 8 such as the manufacture of the injector and/or the vertical portion may have a distinct color added or included. The vertical portion 15 can serve as a static timing reference indicator whereby the height of the vertical portion 15 is thus sized to fit such timing requirements of the particular injector.

As shown in FIG. 4, the invention includes an identification nameplate 2 for a diesel engine fuel injector wherein the injector includes an injector body 30 having holes 18(a-b) at the top of the injector body 30 for receiving filter caps (32a-b). The body 30 further includes an injector stud 38 for securing the injector. The nameplate 2 again includes a mounting portion 10 for securing the nameplate 2 to the top of the injector body. The mounting portion 10 has first and second opposed interface surfaces and a hole 25 positioned within the interface surfaces for receiving the injector stud 38.

In the embodiment of the injector combined with the nameplate 2 the assembly and components are illustrated in U.S. Pat. No. 7,412,971 the contents of which are hereby incorporated in its entirety.

While Applicant has set forth embodiments as illustrated and described above, it is recognized that variations may be made with respect to disclosed embodiments. Therefore, while the invention has been disclosed in various forms only, it will be obvious to those skilled in the art that many additions, deletions and modifications can be made without departing from the spirit and scope of this invention, and no undue limits should be imposed except as set forth in the following claims.

What is claimed is:

1. An identification nameplate for a diesel engine fuel injector wherein the injector includes an injector body having holes at the top of the injector body for receiving filter caps and the body further includes an injector stud for securing the injector, the nameplate comprising:
a mounting portion for securing the nameplate to the top of the injector body, the mounting portion having first and second opposed interface surfaces and a hole positioned within the interface surfaces for receiving the injector stud, the mounting portion further including a pair of holes positioned within the interface surfaces, wherein the pair of holes are aligned with the holes in the injector body which receive the filter caps of the injector; and
an identification portion attached to the mounting portion, the identification portion including indicia.

2. The identification nameplate for a diesel engine fuel injector of claim 1, wherein the nameplate is a unitary piece.

3. The identification nameplate for a diesel engine fuel injector of claim 1, wherein indicia includes a part number identification and/or manufacturing process information.

4. The identification nameplate for a diesel engine fuel injector of claim 1, wherein the identification portion is integral with the mounting portion and is perpendicular to the mounting portion and the identification portion extends over a portion of the fount face of the injector body.

5. The identification nameplate for a diesel engine fuel injector of claim 1, further including a vertical portion attached to the mounting portion and extending up from the top of the injector body.

6. The identification nameplate for a diesel engine fuel injector of claim 5, wherein the vertical portion includes indicia.

7. The identification nameplate for a diesel engine fuel injector of claim 6, wherein the indicia identifies the manufacture of the injector.

8. The identification nameplate for a diesel engine fuel injector of claim 6, wherein the indicia includes a color.

9. The identification nameplate for a diesel engine fuel injector of claim 5, wherein the vertical portion is a static timing reference indicator whereby the height of the vertical portion is thus sized to fit such timing requirements of the particular injector.

10. The identification nameplate for a diesel engine fuel injector of claim 1, wherein the nameplate is formed from steel as a unitary piece.

11. The identification nameplate for a diesel engine fuel injector of claim 1, wherein the pair of holes aligned with the filler cap openings of the injector body are sized to fit a sealing washer to reside within the inner diameter of the pair of holes.

12. An identification nameplate for a diesel engine fuel injector wherein the injector includes an injector body having holes at the top of the injector body for receiving filter caps and the body further includes an injector stud for securing the injector, the nameplate comprising:
a mounting portion for securing the nameplate to the top of the injector body, the mounting portion having first and second opposed interface surfaces and a hole positioned within the interface surfaces for receiving the injector stud, the mounting portion further including a pair of holes positioned within the interface surfaces, wherein the pair of holes are aligned with the holes in the injector body which receive the filter caps of the injector;
an identification portion attached to the mounting portion, the identification portion including indicia; and
a vertical portion attached to the mounting portion and extending up from the top of the injector body.

13. The identification nameplate for a diesel engine fuel injector of claim 12, wherein the nameplate is a unitary piece.

14. The identification nameplate for a diesel engine fuel injector of claim 12, wherein indicia includes a part number identification and/or manufacturing process information.

15. The identification nameplate for a diesel engine fuel injector of claim 12, wherein the identification portion is integral with the mounting portion and is perpendicular to the mounting portion and the identification portion extends over a portion of the fount face of the injector body.

16. The identification nameplate for a diesel engine fuel injector of claim 12, wherein the vertical portion includes indicia.

17. The identification nameplate for a diesel engine fuel injector of claim 16, wherein the indicia identifies the manufacture of the injector.

18. The identification nameplate for a diesel engine fuel injector of claim 12, wherein the vertical portion is a static timing reference indicator whereby the height of the vertical portion is thus sized to fit such timing requirements of the particular injector.

19. The identification nameplate for a diesel engine fuel injector of claim 12, wherein the nameplate is formed from steel as a unitary piece.

20. A fuel injector mechanism for regulating the volume of fuel injected comprising:
a body housing a rotatable plunger slidably fitting within a bushing;
a pair of holes at the top of the injector body for receiving filter caps and an injector stud for securing the injector;
a first and a second port formed within the bushing and a nozzle tip; and
wherein the plunger includes a first and a second opposed ridge and a channel positioned between and defined by the first and second opposed ridges and encircling an axial portion of the plunger; and
a nameplate attached to the fuel injector including a mounting portion having first and second opposed interface surfaces and a hole positioned within the interface surfaces for receiving the injector stud, the mounting portion further including a pair of holes positioned within the interface surfaces, wherein the pair of holes are aligned with the holes in the injector body which receive the filter caps of the injector; an identification portion attached to the mounting portion, the identification portion including indicia; and a vertical portion attached to the mounting portion and extending up from the top of the injector body.
